(19) United States
(12) Patent Application Publication
(10) Pub. No.: US 2014/0358964 A1
(43) Pub. Date: Dec. 4, 2014

(54) Natural language processing (NLP) query formulation engine for a computing device

(71) Applicant: International Business Machines Corporation, Armonk, NY (US)

(72) Inventors: Eric Woods, Durham, NC (US); Corville Orain Allen, Morrisville, NC (US); Scott Robert Carrier, Apex, NC (US)

(73) Assignee: International Business Machines Corporation, Armonk, NY (US)

(21) Appl. No.: 14/267,088

(22) Filed: May 1, 2014

Related U.S. Application Data
(63) Continuation-in-part of application No. 13/903,332, filed on May 28, 2013.

(51) Int. Cl. G06F 17/30

(52) U.S. Cl. CPC G06F 17/30684
USPC 707/769

(57) ABSTRACT

A computing device includes a query formulation engine having a data collection component that collects metadata associated with the device or its operation. Typically, the metadata describes a characteristic about the device (e.g., which components or applications are resident, their current operating states or characteristics, what applications are active, which application has the display focus, what permissions are associated with each application, what application-specific calls are being made to the device operating system, etc.). A natural language processing (NLP)-based question and answer (Q&A) system is trained to understand natural language text queries generated by the query formulation engine. When a user performs an action on the device, the engine converts that action, preferably together with a structured form of the metadata, into an NLP query. The query is directed to the Q&A system. A response to the NLP query is received at the computing device and then acted upon.

### CROSS-REFERENCE TO RELATED APPLICATION

This application is related to Ser. No. 13/903,332, filed May 28, 2013, and titled “Policy enforcement using natural language processing.”

### BACKGROUND OF THE INVENTION

1. Technical Field

This disclosure relates generally to information security and, in particular, to techniques to identify when mobile device users take actions that may violate a use policy.

2. Background of the Related Art

The recent past has seen an enormous growth in the usage and capabilities of mobile devices, such as smartphones, tablets, and the like. Such devices comprise fast processors, large amounts of memory, gesture-based multi-touch screens, and integrated multi-media and GPS hardware chips. Many of these devices use open mobile operating systems, such as Android. The ubiquity, performance and low cost of mobile devices have opened the door for creation of a large variety of mobile applications.

Question answering (or “question and answering,” or “Q&A”) is a type of information retrieval. Given a collection of documents (such as the World Wide Web or a local collection), a Q&A system should be able to retrieve answers to questions posed in natural language. Q&A is regarded as requiring more complex natural language processing (NLP) techniques than other types of information retrieval, such as document retrieval, and it is sometimes regarded as the next step beyond search engines. Closed-domain question answering deals with questions under a specific domain (for example, medicine or automotive maintenance), and it can be seen as an easier task because NLP systems can exploit domain-specific knowledge frequently formalized in ontologies. Open-domain question answering deals with questions about nearly everything, and they can only rely on general ontologies and world knowledge. These systems usually have much more data available from which to extract the answer. Systems of this type are implemented as a computer program, executed on a machine. Typically, user interaction with such a computer program either is via a single user-computer exchange, or a multiple turn dialog between the user and the computer system. Such dialog can involve one or multiple modalities (text, voice, tactile, gesture, or the like). Examples of such interaction include a situation where a cell phone user is asking a question using voice and is receiving an answer in a combination of voice, text and image (e.g. a map with a textual overlay and spoken (computer generated) explanation. Another example would be a user interacting with a video game and dismissing or accepting an answer using machine recognizable gestures or the computer generating tactile output to direct the user. The challenge in building such a system is to understand the query, to find appropriate documents that might contain the answer, and to extract the correct answer to be delivered to the user.

### BRIEF SUMMARY

A computing device such as a smartphone or tablet includes a query formulation engine having a data collection component that collects or captures metadata about or associated with the device. Typically, the metadata describes a characteristic about the device (e.g., which components or applications are resident, what are their current operating states or characteristics, what applications are active, which application has the display focus, what permissions are associated with each application, what application-specific calls are being made to the device operating system, etc.). Metadata may be collected periodically or continuously, or dynamically. A natural language processing (NLP)-based question and answer (Q&A) system distinct from the computing device is trained to understand natural language text queries generated by the query formulation engine. When a user performs an action on the computing device, the query formulation engine converts that action, preferably together with a structured form of the metadata, into a natural language processing (NLP) query. The query is then directed to the Q&A system, which receives the NLP query in a format expected by that system. A response to the NLP query is received at the computing device and then acted upon.

Thus, in one example scenario, the user is attempting to use the device camera to take a photograph of an object within a physical location governed by a use restriction defined in a policy document. The resulting NLP query to the Q&A system might then be “User opened camera application, version 4.1, connected over network [X] to service [Y] with automatic photo upload.” Upon receipt of the query (which preferably includes the structured metadata), the Q&A system determines if the user action is compliant with the policy document. The user's computing device may then take an appropriate action, e.g., policy enforcement, restricting or disabling functionality, alerting or warning the user to non-compliance, or the like.

Using this approach, an action associated with the computing device is translated into a context-specific NLP-based query (to the Q&A system), and the associated response is then processed by an action mechanism operating on or in associated with the computing entity.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 depicts an exemplary block diagram of a distributed data processing environment in which exemplary aspects of the illustrative embodiments may be implemented;

FIG. 2 is an exemplary block diagram of a data processing system in which exemplary aspects of the illustrative embodiments may be implemented;

FIG. 3 illustrates a representative mobile device in which the disclosed subject matter may be implemented;

FIG. 4 illustrates the device of FIG. 3 interacting with a question and answer (Q&A) system, such as a natural language processing (NLP)-based artificial intelligence (AI) learning machine;

FIG. 5 illustrates a representative use case illustrating the basic principle of the natural language text processing of this disclosure;

FIG. 6 illustrates a query formulation engine (e.g., a policy management application) executing in a computing device in one embodiment; and

FIG. 7 illustrates a policy management system in which the query formulation engine may be implemented.

### DETAILED DESCRIPTION OF AN ILLUSTRATIVE EMBODIMENT

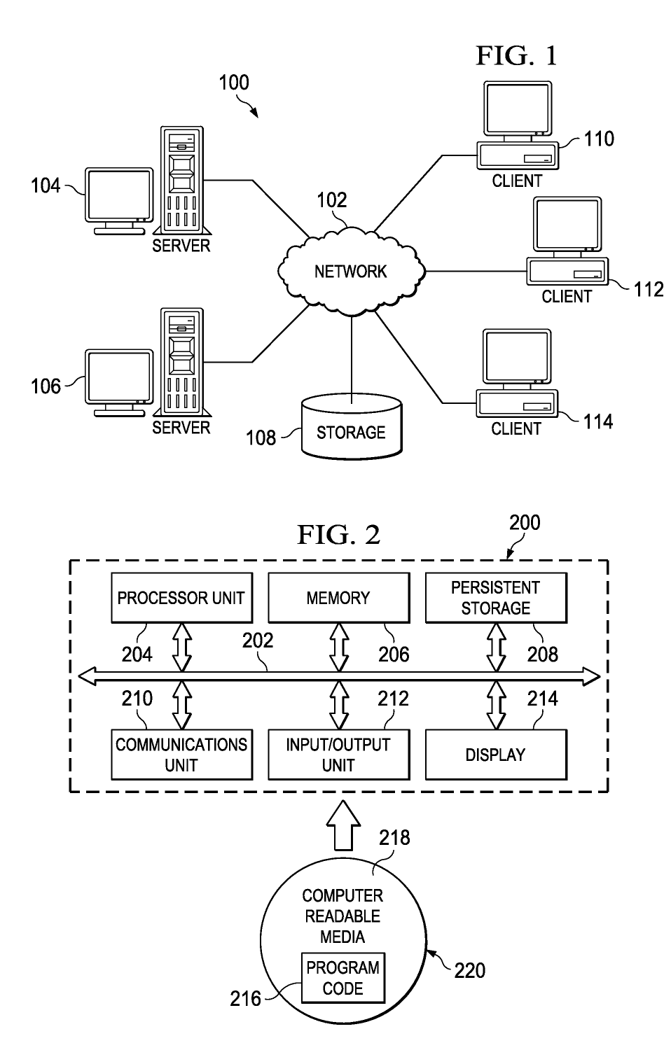

With reference now to the drawings and in particular with reference to FIGS. 1-2, exemplary diagrams of data processing environments are provided in which illustrative embodiments of the disclosure may be implemented. It should be appreciated that FIGS. 1-2 are only exemplary and are not intended to assert or imply any limitation with regard to the environments in which aspects or embodiments of the disclosed subject matter may be implemented. Many modifications to the depicted environments may be made without departing from the spirit and scope of the present invention.

### Client-Server Technologies

With reference now to the drawings, FIG. 1 depicts a pictorial representation of an exemplary distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the disclosed subject matter, and therefore, the particular elements shown in FIG. 1 should not be considered limiting with regard to the environments in which the illustrative embodiments of the present invention may be implemented.

With reference now to FIG. 2, a block diagram of an exemplary data processing system is shown in which aspects of the illustrative embodiments may be implemented. Data processing system 200 is an example of a computer, such as client 110 in FIG. 1, in which computer usable code or instructions implementing the processes for illustrative embodiments of the disclosure may be located.

With reference now to FIG. 2, a block diagram of a data processing system is shown in which illustrative embodiments may be implemented. Data processing system 200 is an example of a computer, such as server 104 or client 110 in FIG. 1, in which computer-usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor (SMP) system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer-usable program code, or computer-readable program code that may be read and executed by a processor in processor unit 204. The program code in the different embodiments may be embodied on different physical or tangible computer-readable media, such as memory 206 or persistent storage 208.

Program code 216 is located in a functional form on computer-readable media 218 that is selectively removable and may be loaded onto or transferred to data processing system 200 for execution by processor unit 204. Program code 216 and computer-readable media 218 form computer program product 220 in these examples. In one example, computer-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 218 also may take the form of a persistent storage, such as a hard drive, a thumb drive, or a flash memory that is connected to data processing system 200. The tangible form of computer-readable media 218 is also referred to as computer-recordable storage media. In some instances, computer-recordable media 218 may not be removable.

Alternatively, program code 216 may be transferred to data processing system 200 from computer-readable media 218 through a communications link to communications unit 210 and/or through a connection to input/output unit 212. The communications link and/or the connection may be physical or wireless in the illustrative examples. The computer-readable media also may take the form of non-tangible media, such as communications links or wireless transmissions containing the program code. The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. As one example, a storage device in data processing system 200 is any hardware apparatus that may store data. Memory 206, persistent storage 208, and computer-readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Computer program code for carrying out operations of the present invention may be written in any combination of one or more programming languages, including an object-oriented programming language such as Java™, Smalltalk, C++, C#, Objective-C, or the like, and conventional procedural programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the SMP system mentioned previously, without departing from the spirit and scope of the disclosed subject matter.

As will be seen, the techniques described herein may operate in conjunction within the standard client-server paradigm such as illustrated in FIG. 1 in which client machines communicate with an Internet-accessible Web-based portal executing on a set of one or more machines. End users operate Internet-connectable devices (e.g., desktop computers, notebook computers, Internet-enabled mobile devices, or the like) that are capable of accessing and interacting with the portal. Typically, each client or server machine is a data processing system such as illustrated in FIG. 2 comprising hardware and software, and these entities communicate with one another over a network, such as the Internet, an intranet, an extranet, a private network, or any other communications medium or link. A data processing system typically includes one or more processors, an operating system, one or more applications, and one or more utilities. The applications on the data processing system provide native support for Web services including, without limitation, support for HTTP, SOAP, XML, WSDL, UDDI, and WSFL, among others. Information regarding SOAP, WSDL, UDDI and WSFL is available from the World Wide Web Consortium (W3C), which is responsible for developing and maintaining these standards; further information regarding HTTP and XML is available from Internet Engineering Task Force (IETF). Familiarity with these standards is presumed.

### Mobile Device Technologies

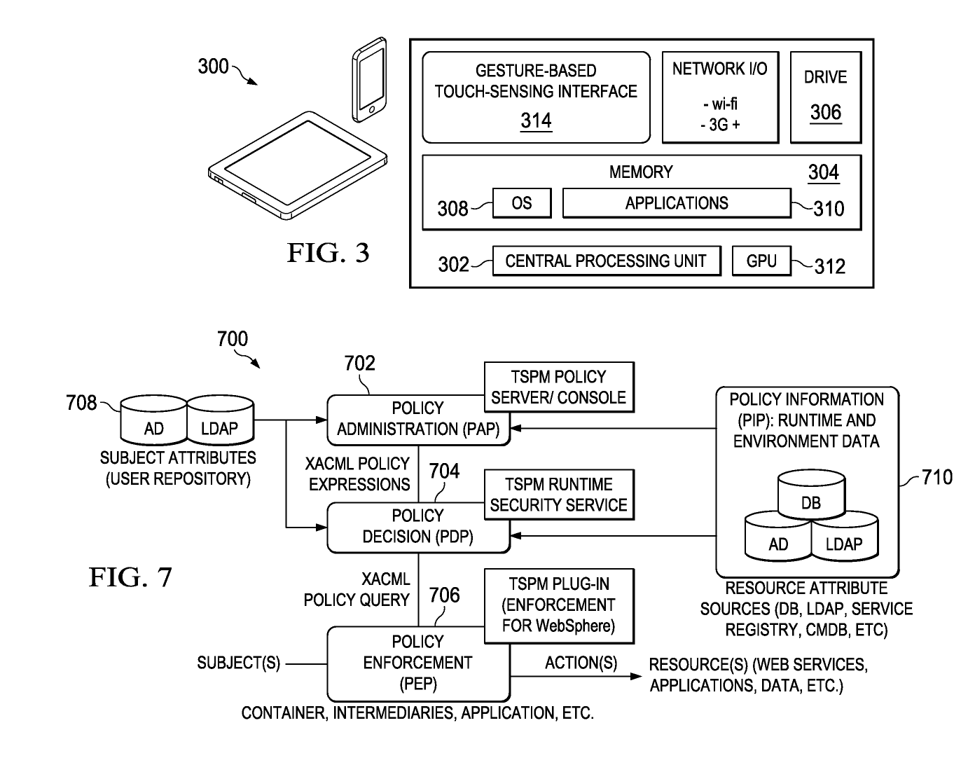

Mobile device technologies also are well-known. A mobile device is a smartphone or tablet, such as the iPhone® or iPad®, an Android™-based mobile device, or the like. As seen in FIG. 3, a device 300 of this type typically comprises a CPU 302, computer memory 304, such as RAM, and a data store 306. The device software includes operating system (e.g., Apple iOS, Android, Blackberry OS, or the like) 308, and generic support applications and utilities 310. Typically, the device includes a separate graphics processing unit (GPU) 312. A touch-sensing device or interface 314, such as a touch screen, is configured to receive input from a user's touch and to send this information to processor 312. The interface 314 responds to gestures on the touch sensitive surface. Other input/output devices include software-based keyboards, cameras, microphones, and the like.

More generally, the mobile device is any wireless client device, e.g., a cellphone, pager, a personal digital assistant (PDA, e.g., with GPRS NIC), a mobile computer with a smartphone client, or the like. Typical wireless protocols are: WiFi, GSM/GPRS, CDMA or WiMax. These protocols implement the ISO/OSI Physical and Data Link layers (Layers 1 & 2) upon which a traditional networking stack is built, complete with IP, TCP, SSL/TLS and HTTP.

Thus, a mobile device as used herein is a 3G- (or next generation) compliant device that includes a subscriber identity module (SIM), which is a smart card that carries subscriber-specific information, mobile equipment (e.g., radio and associated signal processing devices), a man-machine interface (MMI), and one or more interfaces to external devices. The techniques disclosed herein are not limited for use with a mobile device that uses a particular access protocol. The mobile device typically also has support for wireless local area network (WLAN) technologies, such as Wi-Fi. WLAN is based on IEEE 802.11 standards.

### Question Answering

As noted above, question answering (or “question and answering,” or “Q&A”) is a type of information retrieval.

In the past, understanding a query was an open problem because computers do not have human ability to understand natural language, nor do they have common sense to choose from many possible interpretations that elementary natural language understanding systems can produce. A solution that addresses this problem is IBM Watson, which may be described as, among other things, as an open-domain Q&A system that is an NLP artificial intelligence (AI)-based learning machine. A machine of this type may combine natural language processing, machine learning, and hypothesis generation and evaluation; it receives queries and provides direct, confidence-based responses to those queries. A Q&A solution such as IBM Watson may be cloud-based, with the Q&A function delivered “as-a-service” (SaaS) that receives NLP-based queries and returns appropriate answers.

A representative Q&A system, such as described in U.S. Pat. No. 8,275,803, provides answers to questions based on any corpus of data. The method facilitates generating a number of candidate passages from the corpus that answer an input query, and finds the correct resulting answer by collecting supporting evidence from the multiple passages. By analyzing all retrieved passages and that passage's metadata in parallel, there is generated an output plurality of data structures including candidate answers based upon the analyzing step. Then, by each of a plurality of parallel operating modules, supporting passage retrieval operations are performed upon the set of candidate answers; for each candidate answer, the data corpus is traversed to find those passages having candidate answer in addition to query terms. All candidate answers are automatically scored causing the supporting passages by a plurality of scoring modules, each producing a module score. The modules scores are processed to determine one or more query answers; and, a query response is generated for delivery to a user based on the one or more query answers.

In an alternative embodiment, the Q&A system may be implemented using IBM LanguageWare, a natural language processing technology that allows applications to process natural language text. LanguageWare comprises a set of Java libraries that provide various NLP functions such as language identification, text segmentation and tokenization, normalization, entity and relationship extraction, and semantic analysis.

### Restricting or Disabling Device Capabilities Using NLP

With the above as background, the following describes one use case using an NLP system such as described above.

Referring to FIG. 4, the basic concept is shown. According to this embodiment, a computing entity (such as a mobile device) 402 interacts with question and answer (Q&A) system 404, such as a natural language processing (NLP)-based artificial intelligence (AI) learning machine described above. The mobile device is assumed to be operating in a domain having at least one security policy having terms of use. A policy of this type is sometimes referred to herein as a “terms of use security policy.” Such terms may also be delineated under different nomenclature, such as “acceptable use” or mere “usage policy.” The manner in which the policy is designated is not an aspect of this disclosure, as the described technique may be used irrespective of nomenclature variants.

The policy includes one or more “terms of use” 405. Typically, the terms of use depend on the type and nature of the domain. Thus, the terms of use security policy often is domain-specific. The terms may be based on the network to which the device is connected, the user's location (e.g., a workplace), a user's role or responsibilities (e.g., a right to access confidential information), a user authentication, a user authorization, or some combination thereof. As noted above, the techniques of this disclosure are not limited to a particular domain or security policy, or its terms of use. The Q&A system 404 typically is located remotely from the domain, such as in remote location 400, although this is not a limitation or requirement. In the usual case, the Q&A system 404 is accessible over a network, such as a wired or wireline network, a public or private network, or the like. The mobile device interacts with the Q/A system by making queries and receiving answers. A query and its answer may be provided over any suitable transport, securely or in the clear. The mobile device may interact with the Q&A system using a conventional request-response protocol, programmatically, interactively, or otherwise.

Preferably, and as described above, the Q&A system 404 is based on an NLP AI-based learning machine, such as IBM Watson. The use of the described machine is not a limitation, as any Q&A (or, more generally, machine learning) program, tool, device, system, or the like may comprise system 404. Generally, and as has been described, the system 404 combines natural language processing, machine learning, and hypothesis generation and evaluation; preferably, the system 404 receives queries and provides direct, confidence-based responses to those queries. The system may be cloud-based and implemented as a service, or it may be a stand-alone functionality. Regardless of how the Q&A system is implemented, it is assumed to be capable of receiving NLP-based queries and returning answers. As used herein, a “question” and “query,” and their extensions, are used interchangeably and refer to the same concept, namely request for information. Such requests are typically expressed in an interrogative sentence, but they can also be expressed in other forms, for example as a declarative sentence providing a description of an entity of interest (where the request for the identification of the entity can be inferred from the context). The particular manner in which the Q&A system processes queries and provides responses is not an aspect of this disclosure.

As described generally above, a “term of use” policy document defines permissible actions that may be implemented by a user using a computing device. The natural language processing (NLP)-based question and answer (Q&A) system 404 is trained to understand the policy document. Preferably, the computing device includes a policy management application or functionality that is designed to interact with the Q&A system 404 to identify a policy violation (or a potential policy violation). The basic technique is as follows. When the user performs an action on the device, the policy management application converts that action into an NLP query 406 directed to the Q&A system 404 to determine whether the action constitutes a violation. The query may be accompanied by metadata associated with the user, the device or its state. Upon receipt of the query and any associated metadata, the Q&A system 404 determines if the user action is compliant with the policy and returns a response 410. Based on the response, the user's computing device may take a given action, such as a policy enforcement action. The policy enforcement action may be of any type, but typically is some action that restricts or disables functionality on the device to prevent what would otherwise be a policy violation. The given action also may be issuing a notification, such as an alert or warning (that the user is about to violate one of the terms of use). The notification may be audible, tactile or visual. The action may also involve notification of a third party or computing entity.

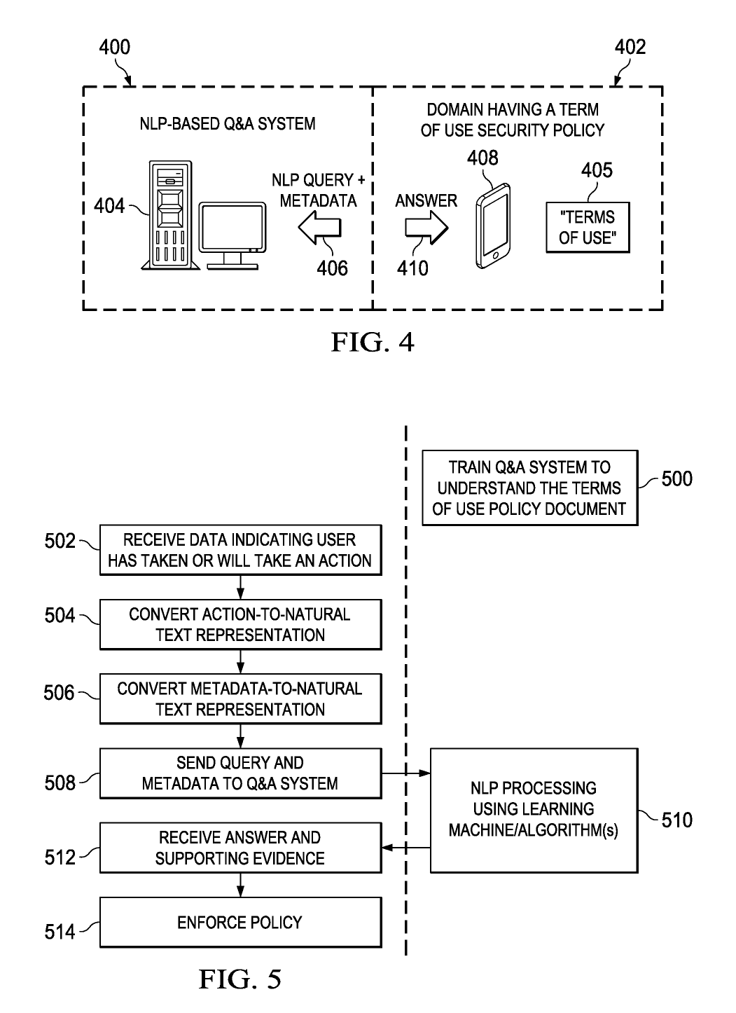

FIG. 5 illustrates a process flow of a method of identifying a policy violation, using an example scenario. In this scenario, which is merely representative, assume that the domain is the premises of a company at which the user is employed. The user's mobile device includes a camera 408. Based on the user's status, it is assumed further that the terms of use for the domain restrict the user from taking photographs of the premises, the facilities, or other physical resources or things. The terms of use might be reflected in the user's employment agreement, in some corporate policy, or otherwise. The method begins at step 500 with the Q&A system trained to understand the terms of use policy document that governs the user's permissible actions. This training is carried out in a conventional manner using the Q&A system, typically in an off-line manner. At step 502, the user performs an action on his or her computing device. The method then continues at step 504 to formulate the user action on the computing device as a question using natural text. To this end, preferably the device includes a policy management application that has the capability to perform an action-to-natural text conversion. Step 504 thus may output a query such as “Can user access the camera from a mobile phone while on this network?” Of course, the actual query will depend on the type of user action. Thus, if the user were to open a browser on the mobile device and attempt to retrieve some network-accessible resource, that action may be translated to the following query: “Can user access {URL} from a mobile phone on this network. At step 506, and as an option, the policy management application may also obtain metadata described the device's state (or some other characteristic) and generate an ancillary query, such as “Mobile device is cloud-enabled; pictures are uploaded automatically.” Once again, the nature of the ancillary query typically depends on the underlying query (that is based on the user action). The metadata may be varied, e.g., it may comprise information associated with or about the user, the device or its state, a target of the action, or the like. Thus, step 506 implements a metadata-to-natural text conversion, where the metadata is data associated with the user, the device or the like but is otherwise distinct from the user action itself. The steps 504 and 506 may be combined (or reversed in sequence), with the resulting query being a single composite query; in the alternative, the metadata may be associated with the main query in some non-natural language-based manner.

At step 508, the main question and the metadata are sent to the Q&A system. The Q&A system processes the query at step 510 and then responds with an answer at step 512. In particular, the Q&A system responds by indicating whether the action is compliant with the governing terms of use set forth in the applicable policy. The response provided at step 512 may include supporting evidence, such as an applicable portion of the policy document. The response may be provided in a text format, in a non-text format, or otherwise. Based on the response, the method then continues at step 514 by taking a given action. The given action will depend on the policy and, in particular, the terms of use, or some other constraint imposed. Generalizing, the action will be domain-specific. Representative actions include, without limitation, restricting a function of the device (e.g., inhibiting the camera, blocking the access request to a URL, etc.), restricting the device functionality (e.g., permitting photographs in certain locations only), issuing an alert that the action is a policy violation and can subject the user to discipline, notifying a third party person or entity of the policy violation, writing a log entry in the user's personnel file, and many others.

As a skilled person will appreciate, the technique described provides a method of formulating user actions on a mobile or other computing device as questions within a designated context or policy profile, inputting said questions into a Q&A system wherein the knowledge corpus is comprised of terms in a governing policy document, detecting non-compliance of the user's action with the policy document, and warning the user or restricting device functionality according to the terms of use. In the above-described embodiment, an enterprise employee is on a campus and using his or her personal mobile device, which is connected to the enterprise network. When the employee performs actions on the phone, these actions are first checked against the enterprise's “terms of use” policy document. If the user's action is non-compliant with the enterprise's policy document, the phone may discourage or prevent the user from taking the action.

Generalizing, it is assumed that the mobile device maintains a policy context domain when in use. Any system features that are to be executed by the user or the device cause the issuance of a request (to the Q&A system) for an approval. In the above-described example scenario, Tthe Q&A system utilizes a corpus of policy documents and terms of use to check for subsequent actions, all within the policy context domain in which the device is operating. A response is given, and the action is either allowed or disallowed.

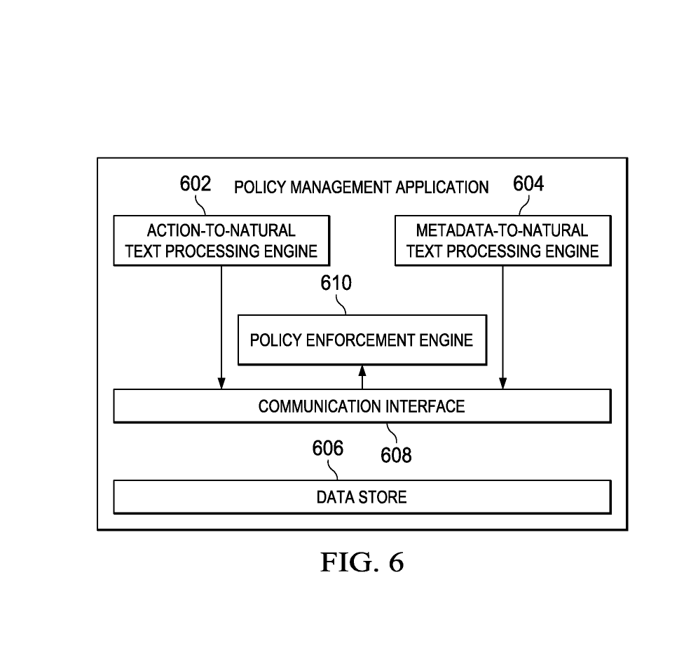

FIG. 6 is a high level block diagram of the basic components of a representative policy management application 600. Typically, the application is implemented in software as set of computer program instruction modules or functions. The application may be integrated within the software operating system (OS), with a well-defined framework for execution and query actions, where the OS acts as a gatekeeper according to the policy profile and context domain. In one embodiment, the policy management application comprises an action-to-natural text processing engine 602, a metadata-to-natural text processing engine 604, a data store 606, a communication interface 608, and a policy enforcement engine 610. These components may be integrated in whole or in part, and one or more components may be provided by other functionality already present in the mobile device. The processing engines 602 and 604 create the queries, the communication interface 608 transmits those queries to the Q/A system and receives the results, and the policy enforcement engine 610 enforces the applicable policy, which is stored in the data store 606. Thus, as in the example described, the user is on the Company campus connected to the Company network on his or her mobile phone. The user then attempts to use the camera. In one embodiment, the processing engines 602 and 604 formulate the action (of using the camera) as a question and include unstructured metadata: “Can I use the camera on my mobile phone while connected to the Company network? This device is cloud-enabled; pictures are automatically uploaded to a third-party service.” The communication interface 608 sends this unstructured question and metadata to a pre-addressed Q&A system, which system may be dedicated for use in the network. The Q&A system responds with a recommendation and supporting evidence; thus, e.g., the system says “No” and references a clause in the terms of use document, “Use of a camera on a device which automatically uploads pictures to a third-party service is prohibited while connected to the Company network.” Based on this response, the policy enforcement engine 610 causes the user's phone to display a warning message “Use of the camera is not permitted on this WiFi network.” In the alternative, the policy enforcement engine 610 may present use of the camera for any purpose, as has been described.

The types of user actions that may trigger a policy enforcement query to the Q/A system may be quite varied and of course will depend on the use case, the policy domain, the type of user, etc. Representative user actions include, without limitation, taking a picture, recording a video, recording an audio conversation, Internet access, network access to a particular resource, web site/page access, initiating a data transfer, and many others.

The metadata associated with the NLP query may be quite varied, as has been described. The metadata may include, without limitation, device state, domain characteristic, date, time, user role, device configuration data, a keyword or object associated with the user action, and many others.

It is not required that the policy enforcement take place on a mobile device. As noted, the natural language processing techniques of this disclosure may be generalized for use in any computing entity. FIG. 7 illustrates a policy management system in which the workflow of this disclosure may be implemented. The system 700 may be implemented across one or more machines operating in a computing environment, such as shown in FIG. 1. Typically, the system comprises a policy administration point (PAP) 702, a policy decision point (PDP) 704, and a policy enforcement point (PEP) 706. Generally, the policy administration point 702 is used to define a consent policy, which may be specified as a set of XACML policy expressions. This policy uses subject attributes provided from a user repository 708, as well runtime and environment data received from policy information point (PIP) 710. The policy decision point (PDP) 704 receives similar information and responds to an XACML policy query received from the policy enforcement point (PEP) 606 to enforce the policy on a subject and with respect to a particular action initiated by the subject. PEP 706 implements the desired consent workflow. In one commercial implementation of this approach, the PAP 702 is implemented by IBM Tivoli® Security Policy Manager (TSPM) policy service or console, the PDP 704 is implemented in the TSPM runtime security service, and the PEP is implemented as a TSPM plug-in to IBM WebSphere® Application Server.

The subject matter described herein has significant advantages over the prior art. Without the use of a natural text system as has been described, any communication between a mobile device and an API that describes permissible/compliant actions necessarily would have to be highly structured and/or rely on a standard to facilitate adoption among all major phone carriers. In essence, the above-described process supports a paradigm shift from communicating with what would be a highly-structured and pre-established API, to a much more unstructured yet highly-flexible API. By implementing such a system in this way (i.e. converting actions to unstructured questions and using a Q&A system), the architecture becomes much more flexible, allowing each phone brand (in the mobile device embodiment) to implement their own question formulation and reactions. The only “pre-established API” is sending a question and receiving an answer. This flexibility provides significant advantages.

In a variant, an employee scans a code (e.g., a QR Code) in his/her company's guidelines and the text for the guidelines is ingested/processed directly on the device. The above-described process (using natural language text processing) can then be used to determine whether an action (e.g. launching a camera app) might lead to a violation of the guideline, and to display a warning along with the guideline snippet in question.

As described above, the particular enforcement action may be quite varied. The system does not necessarily force the device to restrict or inhibit functionality. Rather, the technique presents the opportunity and mechanism by which functionality may be restricted, inhibited, subject to a warning, etc. The nature of the action may also depend on the device or some device characteristic. For example, a Company-issued phone may “force restriction,” while a personal device purchased by the employee may only display a “warning.” The particular enforcement policy is beyond the scope of this disclosure.

### Query Formulation Engine

The above-described policy management application may be generalized as a query generation component, embodiments of which are now described. Preferably, the query generation component performs two distinct functions: metadata collection, both structured and unstructured, and natural language query generation. As explained above, the user action occurs on the device, and it is associated with the metadata collected by the data collection function to facilitate the generation of the natural language text query to the NLP system. In general, the user action typically is a physical action, e.g., activating a component, opening an application, performing an input operation, etc. The user action, as described above, may be associated with a use or other security policy associated with the device. Based on the user action and the metadata collected, and using the query generation component, the action is translated into a natural language query. Preferably, the data collection and query generation functions are executed as computer software, namely, as a set of computer program instructions executing in one or more hardware processors.

The metadata collection process may be quite varied and may involve a variety of data generating sources on the device. Thus, for example, the metadata collection process may collect data or metadata from sources that include, without limitation, one of more of the following: the set of applications that are currently running on the mobile device, the permissions associated with each of those applications (e.g., if those applications have access to particular hardware, to the user's contacts, etc.), device access permissions, device operating state, component operating state (e.g., camera resolution, pixel density, etc.), operating system (OS) version, information regarding OS version updates, information identifying each application level request/call to the device OS (and the OS response), location of the mobile device, device location (e.g., from a GPS, latitude/longitude), time-of-day, day-of-week, other temporal state or data, identification of specialized hardware on the device (e.g., batteries, microphones, cameras, wireless chipsets, touch screens, fingerprint sensors, accelerometers, magnetometers, other biometric sources, and the like), the operating state or status of such specialized hardware, a relative position of an input (e.g., a location of an input to a capacitive touchscreen, an orientation of a device accelerometer relative to a given orientation, or the like), data loss prevention (DLP) information (e.g., identification of certain content or content types that may be secured), data about message senders or recipients, other context information, and the like. This metadata may be collected periodically or continuously, or dynamically (when the particular user action occurs). The metadata collection functionality also may interoperate or receive information from other mobile device sources, such as the software used to convert, interpolate and aggregate fingerprint sample data, the software used to disambiguate user finger data, the software used to identify the user based on some biometric data, and many others. In addition, the metadata collection functionality also may receive information regarding the provenance of the data (e.g., how the data was collected, whether the source is trustworthy, the nature of any trust or confidentiality relationship associated with the data, and the like).

The particular information captured may vary across a wide spectrum from very general to very specific, and the nature, type and/or format of the collected data is not intended to be limited or restricted. An example of general (or “coarse”) data associated with a particular user action may be as follows: “device is running iOS7” or “finger swipe detected.” An example of very specific (or “fine-grained”) metadata associated with a particular user action may be as follows: “User opened twitter app” “accessed network” “accessed keyboard” “input characters ‘h,’ ‘e,’ . . . ”). Another specific example of a particular user action is detection of a particular finger associated with a specific region of a capacitive touchscreen at a particular time and with respect to a particular application having a particular access permission associated therewith. Of course, all of these scenarios are merely representative, as the techniques herein contemplate metadata collection with respect to any of a myriad set of user actions associated with the device. Moreover, a user action itself may be associated with other system- or context-specific information unrelated to a physical action.

As used herein, “metadata” thus comprises information about a characteristic of the mobile device itself, and it is distinct from the information that characterizes the user action itself. Of course, and as described above, typically the metadata is closely related to the user action with which it is associated. Thus, for example, a user action might be opening a camera application while the metadata associated therewith might be the time of day and a current degree of focus of the camera. In another example, the user action is the selection of an icon on a display panel, and the metadata associated therewith is the application layer call to the operating system and the particular coordinates of the user's finger on the capacitive touchscreen. Other metadata may be based on historic information (e.g., “mobile device enabled for cloud storage as of Jan. 1, 2014”). Other metadata may be condition-specific (e.g., “mobile device enabled for picture upload if current cloud storage does not exceed SGB.”) Once again, these are merely illustrative examples and should not be taken to limit this disclosure.

Metadata may also comprise information about a prior NLP query and a response to that NLP query. Thus, particular metadata applied to a user action may take into consideration some prior NLP query-response interaction.

Metadata may also comprise information about a prior user action, irrespective of any NLP query.

Moreover, preferably both unstructured and structured metadata collection is available. Unstructured metadata typically refers to information that is self-contained, meaning that there is no other data (e.g., a defined data model, etc.) about or associated with this data but rather, the only information about the data is contained within the data itself. Typically, unstructured metadata is in a simple format (such as ASCII text), but it may also mean a data set (or composite) generated, e.g., by a scan, a photograph, etc. As used herein, unstructured information might have some structure (i.e., be semi-structured) or even be highly structured but in ways that are unanticipated. In contrast, structured metadata is metadata that fits within a defined data model, schema or template, or the like. Depending on context, particular data may be unstructured or structured, semi-structured, or some combination.

Upon a user action, metadata associated with the user action is obtained. As noted above, this metadata may be pre-existing, determined dynamically (at the time of the user action), or some combination thereof. A test is then performed to determine whether the metadata is structured or unstructured. If the metadata is unstructured, preferably it is first converted into a structured format. The nature of any such conversion will be implementation-specific, and typically the conversion will depend on the type of structured representation (schema, template or data model) that is interpreted by the NLP processing engine. Once the metadata is available in the structured format, the query generation component takes the user action and the structured metadata and performs the (combined) action+metadata→natural text conversion operation. An example of this conversion was described above (steps 504 and 506 in FIG. 5). The particular technique for conversion is once again implementation-specific. In one embodiment, the query formulation engine has an associated database of hardcoded natural language descriptions that are indexed using information derived from the user action, the metadata, or some combination. The database may be implemented as a hash table and indexed for fast lookup and retrieval operations. When the user action and its associated metadata are applied, the result preferably is natural language text suitable for processing by the NLP-based Q/A system (such as system 404 in FIG. 4).

By way of example, assume that the user action is the opening of the camera application on the mobile device. Metadata associated with the device identifies the version of the camera application. The user action-metadata is then mapped by the query formulation engine to the natural language text, such as “User opened the camera application, version 4.1.0.2.” In another example, the user action is the user accessing his or her Twitter account and the typing of a message. If it is assumed that the metadata associated with the device is then capturing interactions between the application and the device OS (e.g., application launch, network access, I/O usage, data entry, etc.), the user action-metadata is then mapped by the query formulation engine to the natural language text, such as “User opened Twitter, accessed corporateWiFi network, accessed keyboard, input message [characters].” The particular semantics of the natural language text of course will depend on the user action, the metadata, and the particular requirements of the NLP Q/A system. There may be multiple types of metadata included in the natural language text, e.g., “User opened the voice recognition application, version 3.5.1, at 10:04, Jul. 31, 2014.” Metadata may be included in the formulation on a conditional basis; if the condition (e.g., as set by a policy or other configuration is met), then the metadata is included in the query.

As can be seen, by collecting (or capturing) a broad array and range of metadata about the computing device and its operating characteristics, and then applying that metadata in a structured format, the query formulation engine can be carried out seamlessly and without requiring that the NLP Q/A system be uniquely tailored or otherwise customized to the mobile device itself. The approach enables specification of a natural language text query (to the NLP Q/A system) that is fine-grained and highly context-specific (due to the combination of the user action information and the specific metadata), thereby enhancing the overall NLP processing.

The query formulation engine described herein (or any portion thereof) may be implemented in the device itself, or in some other machine or device.

Typically, and as described, the query formulation engine has associated therewith some action component or processing element, e.g., an enforcement mechanism that enforces a policy depending on the result obtained by the NLP processing. The action need not be limited to an enforcement of a particular policy, however, as there may be many different and varied user actions that use NLP processing to obtain a response. Thus, for example, the user action may be a simple request for on-line support or assistance. In that context, the user action is some spoken input, and the resulting NLP response is acted upon at the mobile device (e.g., the downloading and obtaining of a software patch or update). The user action and the associated query to the NLP system may generate some response that simply is cached at the mobile device for subsequent use (in the event it is needed). Thus, the NLP response may simply comprise pre-caching of information in anticipation of a future request. The user action and the associated NLP text query may be a simply request for content, and that response to the mobile device may be that content. Thus, as used herein, the “action” that is taken by the mobile device (following the NLP query) may be quite varied and include, without limitation, policy enforcement, data storage or caching, information rendering, data analysis, data logging, and/or combinations thereof. These use case examples are not intended to be limiting.

More generally, the query formulation functionality described above may be implemented as a standalone approach, e.g., a software-based function executed by a processor, or it may be available as a managed service (including as a web service via a SOAP/XML interface), in whole or in part. The particular hardware and software implementation details described herein are merely for illustrative purposes are not meant to limit the scope of the described subject matter.

More generally, computing devices within the context of the disclosed subject matter are each a data processing system (such as shown in FIG. 2, or FIG. 3) comprising hardware and software, and these entities communicate with one another over a network, such as the Internet, an intranet, an extranet, a private network, or any other communications medium or link. The applications on the data processing system provide native support for Web and other known services and protocols including, without limitation, support for HTTP, FTP, SMTP, SOAP, XML, WSDL, UDDI, and WSFL, among others. Information regarding SOAP, WSDL, UDDI and WSFL is available from the World Wide Web Consortium (W3C), which is responsible for developing and maintaining these standards; further information regarding HTTP, FTP, SMTP and XML is available from Internet Engineering Task Force (IETF). Familiarity with these known standards and protocols is presumed.

The scheme described herein may be implemented in or in conjunction with various server-side architectures including simple n-tier architectures, web portals, federated systems, and the like. As noted, the techniques herein may be practiced in a loosely-coupled server (including a “cloud”-based) environment.

Still more generally, the subject matter described herein can take the form of an entirely hardware embodiment, an entirely software embodiment or an embodiment containing both hardware and software elements. In a preferred embodiment, the functionality of the query generation component is implemented in software, which includes but is not limited to firmware, resident software, microcode, and the like. The functions may be integrated into other applications, or built into software for this specific purpose (of facilitating the natural language query generation. Furthermore, the device-specific functionality may take the form of a computer program product accessible from a computer-usable or computer-readable medium providing program code for use by or in connection with a computer or any instruction execution system. For the purposes of this description, a computer-usable or computer readable medium can be any apparatus that can contain or store the program for use by or in connection with the instruction execution system, apparatus, or device. The medium can be an electronic, magnetic, optical, electromagnetic, infrared, or a semiconductor system (or apparatus or device). Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. A computer-readable storage medium is a tangible, non-transitory item.

The computer program product may be a product having program instructions (or program code) to implement one or more of the described functions. Those instructions or code may be stored in a computer readable storage medium in a data processing system after being downloaded over a network from a remote data processing system. Or, those instructions or code may be stored in a computer readable storage medium in a server data processing system and adapted to be downloaded over a network to a remote data processing system for use in a computer readable storage medium within the remote system.

In a representative embodiment, the device-specific components are implemented in a special purpose computing platform, preferably in software executed by one or more processors. The software is maintained in one or more data stores or memories associated with the one or more processors, and the software may be implemented as one or more computer programs. Collectively, this special-purpose hardware and software comprises the functionality described above.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

Finally, while given components of the system have been described separately, one of ordinary skill will appreciate that some of the functions may be combined or shared in given instructions, program sequences, code portions, and the like.

As used herein, a “client-side” application should be broadly construed to refer to an application, a page associated with that application, or some other resource or function invoked by a client-side request to the application. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

The computing entity is not limited to any particular device, configuration, or functionality. The technique may be implemented from any computing entity, including mobile phone, tablet, laptop, notebook, desktop, television, electronic gaming system, intelligent vehicle, or other system or appliance.

Having described our invention, what we now claim is as follows.

1. A method to generate a natural language query in association with a computing entity, comprising:
obtaining metadata associated with the computing entity;
responsive to receipt of information associated with a user action, the information being distinct from the metadata, mapping the information, together with a structured version of the metadata, into a natural text query;
receiving a response to the natural text query, the response having been generated by applying the natural text query against a knowledge corpus; and
taking an action in association with the computing entity based on the response;
wherein at least one of the collecting, mapping, receiving and taking steps is carried out using a computer program executing on a hardware element.

2. The method as described in claim 1 wherein the metadata is one of: an identification of one or more hardware components, an identification of one or more applications, an identification of one or more permissions associated with at least one hardware component or application, a current operating state or characteristic of a hardware component or application, an operating system interaction, a physical location of the computing entity, temporal data, a touchscreen location, information identifying given content, information identifying a given source or target, information identifying a display screen focus or display resolution, information about a provenance of given data, information associated with a prior query or user action, and combinations thereof.

3. The method as described in claim 1 further including converting metadata obtained in an unstructured format to the structured version of the metadata.

4. The method as described in claim 1 wherein the metadata is obtained periodically, continuously or in association with the user action.

5. The method as described in claim 1 wherein the action is one of: launching an input device associated with the computing entity, activating an application on the computing entity, attempting to access a network from the computing entity, initiating a data transfer from the computing entity, caching the response, and providing a response to a support request.

6. The method as described in claim 1 wherein the response is generated by a question and answer (Q&A) system that analyzes its knowledge corpus.

7. The method as described in claim 1 wherein the computing entity is a mobile device and the natural text query is context-specific and based on a current operating condition associated with the mobile device.

8. Apparatus, comprising:
a processor; and
computer memory holding computer program instructions executed by the processor, to generate a natural language query, the computer program instructions comprising:
code to obtain metadata associated with the computing entity;
code operative in response to receipt of information associated with a user action, the information being distinct from the metadata, to map the information, together with a structured version of the metadata, into a natural text query;
code to receive a response to the natural text query, the response having been generated by applying the natural text query against a knowledge corpus; and
code operative to take an action in association with the computing entity based on the response.

9. The apparatus as described in claim 8 wherein the metadata is one of: an identification of one or more hardware components, an identification of one or more applications, an identification of one or more permissions associated with at least one hardware component or application, a current operating state or characteristic of a hardware component or application, an operating system interaction, a physical location of the computing entity, temporal data, a touchscreen location, information identifying given content, information identifying a given source or target, information identifying a display screen focus or display resolution, information about a provenance of given data, information associated with a prior query or user action, and combinations thereof.

10. The apparatus as described in claim 8 further including code operative to convert metadata obtained in an unstructured format to the structured version of the metadata.

11. The apparatus as described in claim 8 wherein the metadata is obtained periodically, continuously or in association with the user action.

12. The apparatus as described in claim 8 wherein the action is one of: launching an input device associated with the computing entity, activating an application on the computing entity, attempting to access a network from the computing entity, initiating a data transfer from the computing entity, caching the response, and providing a response to a support request.

13. The apparatus as described in claim 8 wherein the response is generated by a question and answer (Q&A) system that analyzes its knowledge corpus.

14. The apparatus as described in claim 8 wherein the natural text query is context-specific based on a current use condition associated with a mobile device.

15. A computer program product in a non-transitory computer readable storage medium for use in a computing entity, the computer program product holding computer program instructions which, when executed, perform a method to generate a natural language text query, the computer program instructions comprising:
code to obtain metadata associated with the computing entity;
code operative in response to receipt of information associated with a user action, the information being distinct from the metadata, to map the information, together with a structured version of the metadata, into a natural text query;
code to receive a response to the natural text query, the response having been generated by applying the natural text query against a knowledge corpus; and
code operative to take an action in association with the computing entity based on the response.

16. The computer program product as described in claim 15 wherein the metadata is one of: an identification of one or more hardware components, an identification of one or more applications, an identification of one or more permissions associated with at least one hardware component or application, a current operating state or characteristic of a hardware component or application, an operating system interaction, a physical location of the computing entity, temporal data, a touchscreen location, information identifying given content, information identifying a given source or target, information identifying a display screen focus or display resolution, information about a provenance of given data, information associated with a prior query or user action, and combinations thereof.

17. The computer program product as described in claim 15 further including code operative to convert metadata obtained in an unstructured format to the structured version of the metadata.

18. The computer program product as described in claim 15 wherein the metadata is obtained periodically, continuously or in association with the user action.

19. The computer program product as described in claim 15 wherein the action is one of: launching an input device associated with the computing entity, activating an application on the computing entity, attempting to access a network from the computing entity, initiating a data transfer from the computing entity, caching the response, and providing a response to a support request.

20. The computer program product as described in claim 15 wherein the response is generated by a question and answer (Q&A) system that analyzes its knowledge corpus.

21. The computer program product as described in claim 15 wherein the natural text query is context-specific based on a current use condition associated with a mobile device.
